(19) United States
(12) Patent Application Publication
(10) Pub. No.: US 2026/0175995 A1
(43) Pub. Date: Jun. 25, 2026

(54) METHOD AND APPARATUS FOR AIRPORT NAVIGATION

(71) Applicant: Airbus SAS, BLAGNAC (FR)

(72) Inventors: Benjamin MAZOIN, BLAGNAC (FR); Emeline FLORES, BLAGNAC (FR); Denis PELLERIN, BLAGNAC (FR)

(21) Appl. No.: 19/421,706

(22) Filed: Dec. 16, 2025

Related U.S. Application Data
(60) Provisional application No. 63/736,848, filed on Dec. 20, 2024.

(51) Int. Cl. B64F 1/00

(52) U.S. Cl. CPC B64F 1/002

(57) ABSTRACT

A method for assisting a pilot navigate an airport while taxiing an aircraft, the method comprising receiving taxi instructions for the aircraft to reach a destination from an origin, generating at least one taxi route for the aircraft to reach the destination from the origin, displaying navigation instructions corresponding to one of the at least one generated taxi route via a display device of the aircraft, and executing the navigation instructions according to the generated taxi route.

### CROSS-REFERENCES TO RELATED APPLICATIONS

This application claims the benefit of the U.S. Provisional Patent Application No. 63/736,848 filed on Dec. 20, 2024, the entire disclosure of which is incorporated herein by way of reference.

### FIELD OF THE INVENTION

The invention relates to a method and apparatus for airport navigation, and more specifically, a method and apparatus for generating and displaying a taxi route for an aircraft at an airport.

### BACKGROUND OF THE INVENTION

Navigating an aircraft through an airport can result in a high workload for pilots. In addition to driving the aircraft, communication with the control tower and with other actors on the ground, managing commercial operations, and systems management, pilots must also manage navigation at the airports. Navigation can be complex due to the infrastructure (e.g., many turns), traffic which can be congested, and mobile or non-moving obstacles (e.g., buildings, poles, vehicles, people, etc.). In this context, inserting or modifying a route and then following it requires a workload that can be high for a pilot.

Existing systems do not enable a semi-hands-off approach to enable pilots to focus on taxiing the aircraft while still ensuring they are on the appropriate route. Therefore, there exists a need to not only assist pilots in ensuring they are following the appropriate route, but to also generate and/or update a generated route based on airport conditions or changes to the route.

### SUMMARY OF THE INVENTION

As disclosed herein, methods and systems are presented for creating taxiing routes, modifying them, and for navigating as part of an aircraft taxiing operation at an airport. Said methods and systems are configured to assist a pilot or automated system in performing a taxiing operation to navigate an airport. Said methods and systems compose processing circuitry configured to generate and display a route for an aircraft to take as well as events present on this route, such as waiting points before crossing a take-off runway or any other element of this route and, a map showing the aircraft on the airport and its route.

Accordingly, in an aspect of the present invention, the present invention may be generally characterized as a method for assisting a pilot navigate an airport while taxiing an aircraft, the method comprising receiving taxi instructions for the aircraft to reach a destination from an origin, generating at least one taxi route for the aircraft to reach the destination from the origin, displaying navigation instructions corresponding to one of the at least one generated taxi route via a display device of the aircraft, and executing the navigation instructions according to the generated taxi route.

The method may include inserting the received taxi instructions into the display device of the aircraft prior to generating the at least one taxi route.

The method may include modifying the navigation instructions when a change to the at least one generated taxi route has been detected.

The method may include generating the at least one taxi route based on one or more additional considerations comprising identifying predetermined or common taxi routes at the airport, determining a desired fuel economy criteria, or identifying anchor points inserted into taxi route.

The method may include generating a taxi route preview corresponding to the at least one generated taxi routes.

The method may include updating the route preview based on changes made to the at least one generated taxi route after generating the route preview.

The method may include generating a prompt to confirm one of the at least one generated taxi route to generate the navigation instructions.

The method may include displaying a portion of the navigation instructions and a current position of the aircraft on the display device.

The method may include updating the portion of the navigation instructions based on the current position of the aircraft.

The method may include generating at least one indicator corresponding to an anticipated action during execution of the navigation instructions.

The method may include displaying the navigation instructions on a map corresponding to the airport.

The method may include displaying an anticipated position of the aircraft corresponding to a future position of the navigation instructions.

The method may include comparing the at least one generated taxi route with an alternative route.

The method may include comparing the at least one generated taxi route with an alternative route prior to or during execution of the navigation instructions.

In another aspect, the present invention may be characterized as providing an apparatus for assisting a pilot navigate an airport while taxiing an aircraft, said apparatus comprising processing circuitry configured to execute machine-readable instructions to perform the method according to any of the preceding combinations.

In another aspect, the present invention may be characterized as providing an aircraft comprising a fuselage, a pair of wings attached to the fuselage, at least one engine configured to propel the aircraft, and the apparatus according to any of the preceding combinations.

In another aspect, the present invention may be characterized as providing a non-transitory computer readable medium comprising memory, machine-readable instructions stored on the memory, and a processing unit configured to execute the machine-readable instructions to perform the method according to any of the preceding combinations.

These and other aspects and embodiments of the present invention will be appreciated by those of ordinary skill in the art based upon the following description of the drawings and detailed description of the preferred embodiments.

The apparatus disclosed herein improves ease of airport navigation by allowing the pilot to manage taxi routes and the presentation of navigation instructions on display(s) of the aircraft, and by enabling the pilot to anticipate future events and/or change the route to avoid undesired situations such as taxiway closures or obstacles.

### BRIEF DESCRIPTION OF THE DRAWINGS

Embodiments of the invention are described in more detail with reference to the accompanying schematic drawings that are listed below:

FIG. 1 depicts an aircraft including an airport navigation system according to the examples provided herein;

FIG. 2 is a system diagram of the airport navigation system of FIG. 1;

FIG. 3 illustrates a process for the airport navigation system of FIG. 1 to generate and display a taxi route;

FIG. 4 illustrates a process for the airport navigation system of FIG. 1 to generate the taxi route;

FIG. 5 illustrates a process for the airport navigation system of FIG. 1 to display navigation instructions according to the generated taxi route of FIG. 4; and,

FIG. 6 is a block diagram of a computing device configured to execute the processes of FIGS. 3-5.

In general, the same reference numbers listed throughout the drawings represent the same feature.

### DETAILED DESCRIPTION OF THE PREFERRED EMBODIMENTS

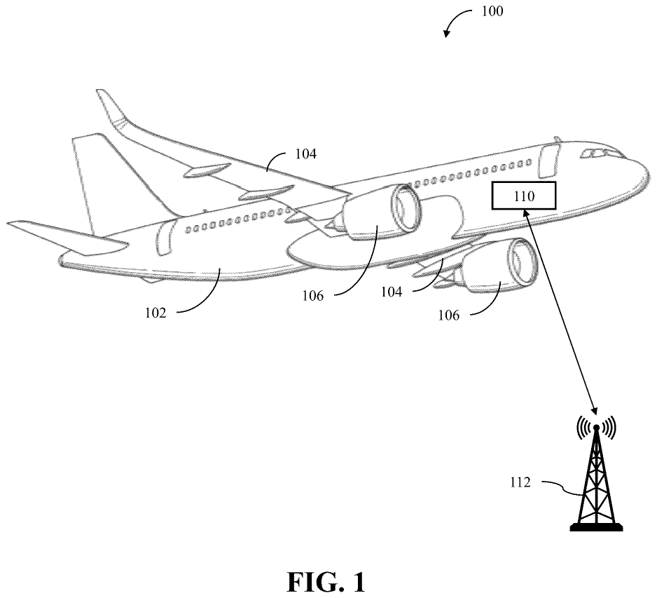

Referring to FIG. 1, an aircraft 100 is illustrated which includes a fuselage 102 and a pair of wings 104 symmetrically distributed and attached to the fuselage 102. The aircraft 100 further includes at least one engine 106 designed to propel the aircraft 100. While two engines 106 are depicted in FIG. 1, it should be understood that the aircraft 100 can include more or less than two engines 106, and the associated description herein is applicable to aircraft including more or less than two engines 106.

The aircraft 100 includes an airport navigation system 110. The airport navigation system 110 is configured to be in communication with air traffic control (ATC) or any other form of communication entity (e.g., a communication tower 112) for sending and/or receiving instructions. The airport navigation system 110 as described herein includes two parts:
A first part of the airport navigation system 110 corresponds to navigation icons displayed on a screen in the cockpit of the aircraft, presenting and displaying a taxi route and/or taxi route options. Preferably, these navigation icons are integrated into a banner. For example, this banner can be vertical. However, the banner can take any other shape (linear horizontal, rounded, in three dimensions, projected on the route, in a circle, etc.). The icons can take any shape, with any graphic effect. It should be understood that the graphical interface for the navigation icons can change depending on the avionics setup, pilot preferences, cockpit restrictions, etc. Notably, the processes as described herein do not limit the navigation icons to any particular orientation or design.

A second part of the airport navigation system 110 corresponds to a map also displayed on the screen. This map can be presented in any form (in two dimensions, in three dimensions, conical or isometric, etc.) with a graphic layer which can also be in any form (satellite, plan, minimalist, etc.).

As is described herein, the airport navigation system 110 is configured to allow the implementation of several functions, in particular the following four functions: (I) inserting and modifying a route, (II) presentation of navigation instructions, (III) visualizing the future of the route by manipulating the apparatus in the form of a “ghost” copy of the aircraft, and (IV) comparing a route already inserted and a route under construction before validation of any change.

Although the methods and systems as described herein are primarily tailored to taxiing from an origin to a departure runway (e.g., gate to runway), it should be understood that the method and systems as described herein are applicable to any taxiing system regardless of directionality (e.g., from arrival runway to gate, from fuel station to departure runway, etc.).

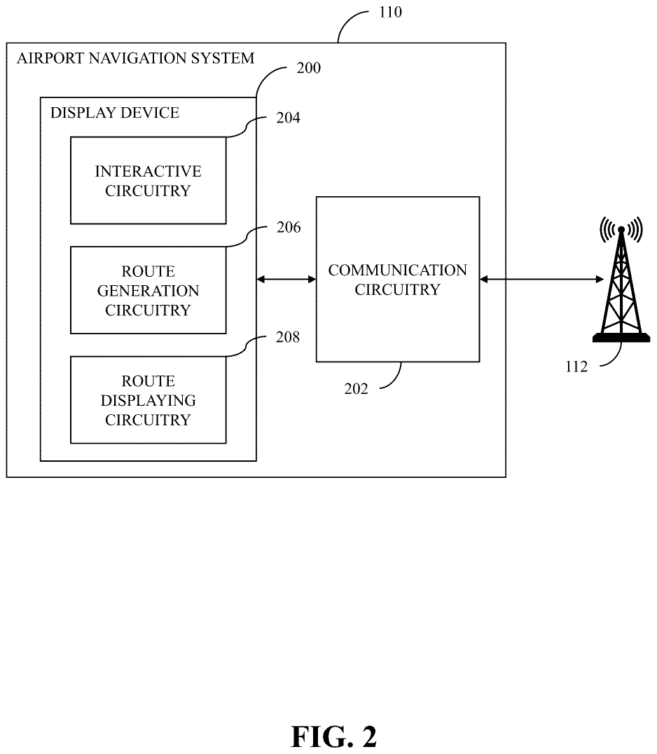

FIG. 2 is a system diagram of the airport navigation system 110 of FIG. 1. The airport navigation system 110 includes a display device 200 and communication circuitry 202 configured to be in communication with the communication tower 112. In the examples described herein, the display device 200 is a primary flight display (PFD), one or more avionics panels, or any other suitable device capable of displaying an output within the aircraft 100.

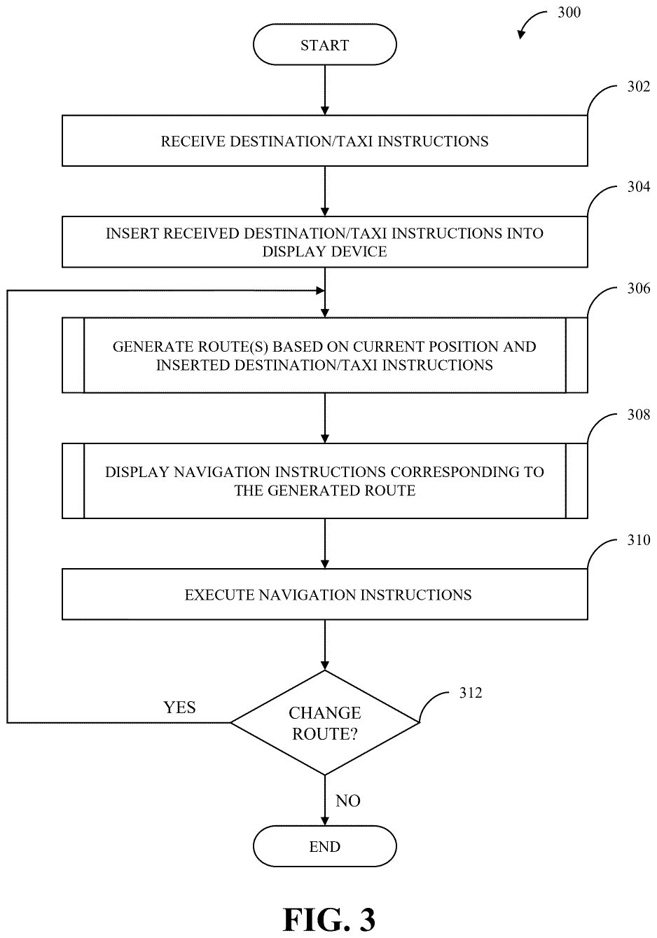

The display device 200 includes interactive circuitry 204, route generation circuitry 206, and route displaying circuitry 208. According to the examples herein, the communication circuitry 202, the interactive circuitry 204, the route generation circuitry 206, and the route displaying circuitry 208 are configured to execute machine-readable instructions to execute the processes described in connection with FIGS. 3-5.

The communication circuitry 202 is configured to send and receive instructions from the communication tower 112 and communicate said instructions to/from the display device 200. The instructions can include any information pertinent to operation of the aircraft 100 including, but not limited to, taxiway route instructions, departure runway location, airport obstructions such as construction or objects on taxi surfaces, location of other airport traffic, etc.

The interactive circuitry 204 enables a pilot, operator, or automated system to input, view, and/or modify route instructions or display options. In some examples, the interactive circuitry 204 collects information inputted by the pilot (e.g., departure runway location, preferred taxi routes, etc.) for use by the route generation circuitry 206 and the route displaying circuitry 208. In other examples, the interactive circuitry 204 receives the instructions from the communication circuitry 202 and automatically collects the information for subsequent use. The interactive circuitry 204 can take the form of a touchpad display, a series of buttons, scroll wheel, or any other form of input device.

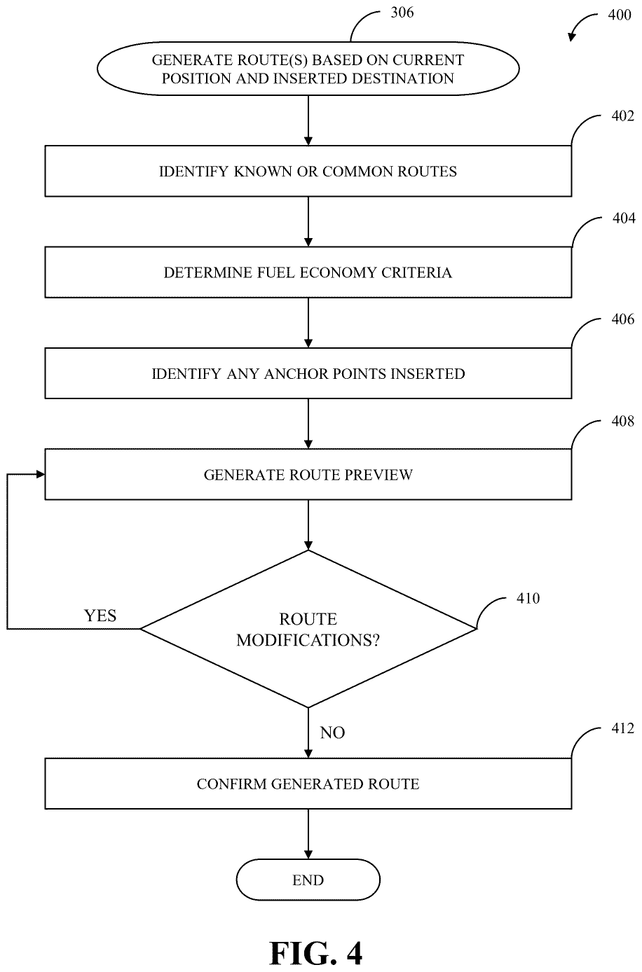

The route generation circuitry 206 generates a taxi route based on the collected information from the interactive circuitry 204. The route generation circuitry 206 further accounts for additional criteria, such as known taxi routes, preferred fuel economy, anchor points set by the pilot, and/or any other suitable criteria to determine the appropriate route for the aircraft 100 to follow. The route generation circuitry 206 is further described in reference to FIG. 4 below.

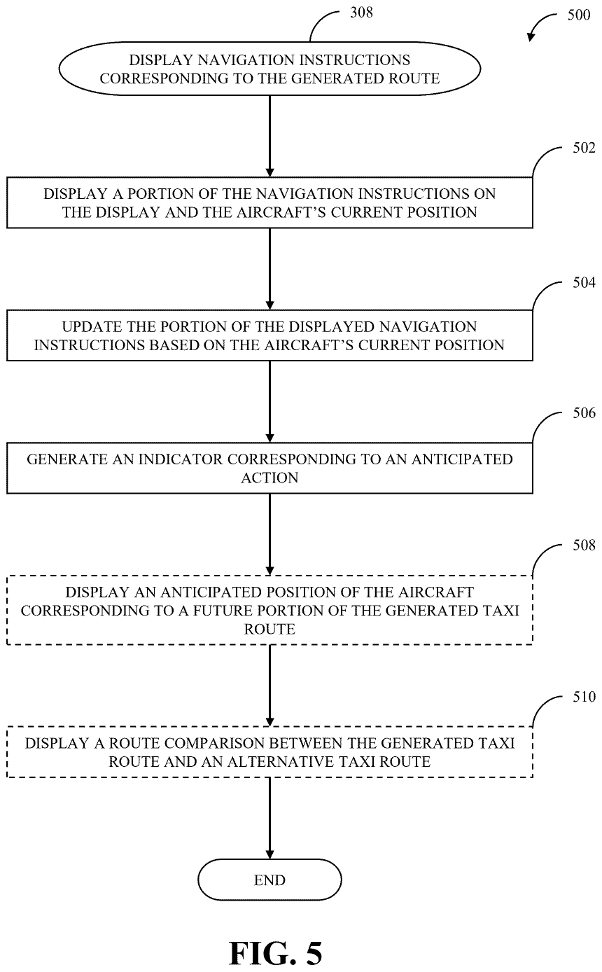

The route displaying circuitry 208 displays the current position of the aircraft 100, navigation instructions according to a generated taxi route, updates to the generated taxi route, a comparison of the generated taxi route with an alternative taxi route, a future or anticipated position of the aircraft 100, and/or indicators for anticipated actions on the display device 200. In the examples disclosed herein, the route displaying circuitry 208 displays the navigation instructions on a map of the airport, either 2-dimensional or three-dimensional, with either a fixed or free camera view. The route displaying circuitry 208 is further described in reference to FIG. 5 below.

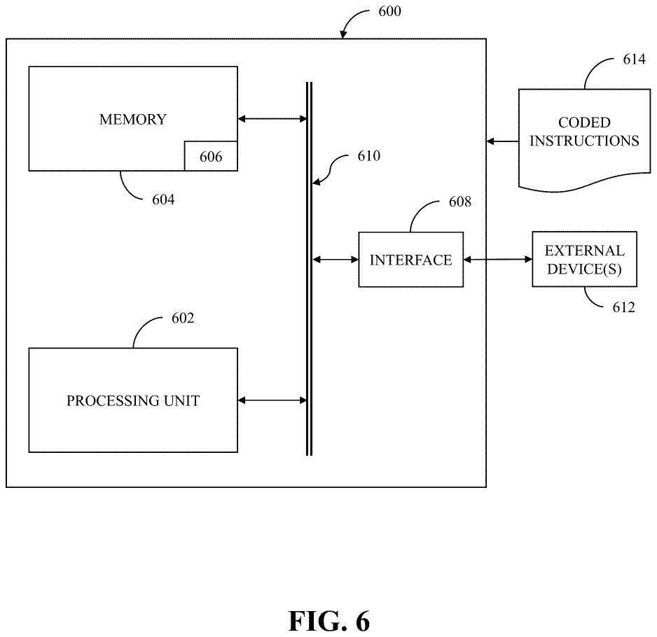

FIG. 3 illustrates a process 300 for the airport navigation system 110 of FIG. 1 to generate and display the taxi route. The process 300 of FIG. 3 is implemented using a processor or computing unit according to the description of FIG. 6.

At block 302, the communication circuitry 202 receives destination and/or taxi instructions from the communication tower 112. In some examples, the destination and/or taxi instructions include a departure runway, a fuel station, a de-icing station, etc. In other examples, more details can be received by the communication circuitry 202 such as taxiway obstacles, closures, other traffic, etc.

At block 304, the interactive circuitry 204 inserts the received destination/taxi instructions into the display device 200. In some examples, the pilot inputs the destination/taxi instructions into the display device 200 manually. In other examples, the airport navigation system 110 can automatically detect the destination/taxi instructions and provide said instructions to the interactive circuitry 204 (e.g., via audibly detecting the instructions, transcribing text data, etc.).

In some examples, the pilot selects the destination and/or waypoints proposed contextually based on a combination of data (Automatic Terminal Information Service (ATIS), ATC, airport flight statistics, Notice to Airmen (NOTAMS) or any other resource producing or providing data).

The interactive circuitry 204 inserts the instructions into the display device 200 via any one or more of a virtual or physical keyboard, voice transcription, textual transcription, extraction of data, etc.

At block 306, the route generation circuitry 206 generates the taxi route based on the received and inserted destination/taxi instructions originating from the current position of the aircraft 100. In some examples, the route generation circuitry 206 generates the taxi route according to the best or most efficient route to take to reach the destination (e.g., shortest distance between origin point and the destination). In other examples, the taxi route is generated based on a preferred fuel economy, anchor points set by the pilot (e.g., points along the taxi route in which the airport navigation system 110 shall not adjust or modify), or any other identifiable consideration. Accordingly, the taxi route generated by the route generation circuitry 206 can be modified based on the pilot's input and/or changes to operating conditions.

According to the examples disclosed herein, the route generation circuitry 206 continually updates the generated taxi route and/or generates alternative routes based on current conditions of the airport and/or the current position of the aircraft 100.

Further, in some examples, multiple taxi routes can be generated. In such an example, there may be multiple taxi routes that comply with the instructions and/or inputs from the pilot or automated system. Accordingly, the pilot or automated system may select the best or preferred route from the multiple generated taxi routes.

At block 308, the route displaying circuitry 208 displays the navigation instructions on the display device 200. In some examples, the displayed taxi route includes only a portion of the total taxi route and follows the aircraft 100 as the aircraft 100 is moving (e.g., following the aircraft 100 while taxiing). In some examples, the displayed taxi route illustrates one or more indicators corresponding to an action that needs to be taken (e.g., a turn icon, a stop icon, etc.). Further, in some examples, the route displaying circuitry 208 displays a future or anticipated position of the aircraft 100 along the generated taxi route (e.g., a “ghost” aircraft indicating where the aircraft 100 is expected to be at a future portion of the generated taxi route).

According to the examples disclosed herein, the taxi route that is generated is a list or illustration of the route needed to go from an origin point to a destination point, and the navigation instructions are the instructions that are presented to the pilot or automated system to execute the generated taxi route.

At block 310, the navigation instructions corresponding to the generated taxi route are executed. In some examples, the navigation instructions are executed by the pilot taxiing the aircraft 100 according to the generated taxi route. In other examples, the navigation instructions are executed by an automated system taxiing the aircraft 100 according to the generated taxi route (e.g., via the processing unit described in connection with FIG. 6).

At block 312, the route generation circuitry 206 determines if there are any changes to the generated taxi route. Changes to the generated taxi route can include manual changes inputted by the pilot, received instructions from the communication tower 112 to deviate from the previously generated taxi route, or any other manual or automated change.

If the route generation circuitry 206 determines that changes are to be made to the generated taxi route (e.g., block 312 outputs a YES), then blocks 306-310 are repeated to generate a new taxi route based on the changes detected and/or inputted.

If the route generation circuitry 206 determines that no changes are to be made to the generated taxi route (e.g., block 312 outputs a NO), then the process 300 of FIG. 3 ends and the airport navigation system 110 executes the navigation instructions until completion.

In some examples, the route generation circuitry 206 is continually checking the generated route to determine if any changes need to be made or alerted to the pilot or automated system (e.g., during execution of the navigation instructions). Such examples include alerting whether the generated taxi route has an obstacle, whether a faster or more desirable route has been found, or whether the generated taxi route is to be modified based on received instructions from the communication tower 112. Accordingly, the route generation circuitry 206 can generate a new taxi route even while the navigation instructions are being executed.

FIG. 4 illustrates a process 400 for the airport navigation system 110 of FIG. 1 to generate the taxi route, using the route generation circuitry 206. The process 400 of FIG. 5 is implemented using the processor or computing unit according to the description of FIG. 6.

At block 402, the route generation circuitry 206 identifies known or common routes to reach the destination. In some examples, it is desirable to generate the taxi route based on a recurrence of the route (e.g., a typical route taken to reach the destination) or a currently used route which may differ from a historical route (e.g., a taxi route that deviates from how the route would be operated historically due to airport conditions).

At block 404, the route generation circuitry 206 identifies fuel economy criteria for determining the appropriate taxi route to generate. In some examples, the shortest route is not always the most fuel efficient route, and in cases where fuel economy is considered, the generated taxi route accounts for said desired fuel economy.

At block 406, the route generation circuitry 206 identifies any anchor points set by the pilot and/or automated system. As described above, anchor points are points along the taxi route in which the airport navigation system 110 shall not adjust or modify. Such anchor points can include preferred taxi route waypoints based on a pilot's familiarity or comfort with a given route, unexpected or unknown obstacles on the runway, etc.

Once all additional criterion are inputted and/or considered, the route generation circuitry 206 generates a route preview accordingly at block 408. The route preview shows the entirety of the generated taxi route based on all available instructions and considerations. In some examples, as explained above, multiple routes can be generated that comply with the instructions and considerations described above. In such an example, multiple route previews can be generated according to each generated taxi route.

At block 410, the route generation circuitry 206 determines if any route modifications have been detected. In some examples, the route preview may indicate to the pilot or automated system an undesired taxi route or that one or more additional considerations are desired. Such indications can lead to modifications of the generated taxi route accordingly.

If the route generation circuitry 206 detects that the generated taxi route has been modified (e.g., block 410 outputs a YES), the route generation circuitry 206 generates a new route preview according to block 408. If the route generation circuitry 206 detects than no changes have been made, the process 400 of FIG. 4 proceeds.

At block 412, the route generation circuitry 206 generates a prompt to confirm the taxi route generated. In some examples, if multiple taxi routes are generated, the pilot or automated system confirms one of the multiple taxi routes generated. Once the generated taxi route is confirmed, the process 400 of FIG. 4 concludes.

FIG. 5 illustrates a process 500 for the airport navigation system 110 of FIG. 1 to display the navigation instructions according to the generated taxi route of FIG. 4 using the route displaying circuitry 208. The process 500 of FIG. 5 is implemented using the processor or computing unit according to the description of FIG. 6.

At block 502, the route displaying circuitry 208 displays a portion of the navigation instructions and the current position of the aircraft 100 on the display device 200. In some examples, the portion of the navigation instructions is suitable for the pilot to understand the current position of the aircraft 100 and any immediate future actions that need to be taken (e.g., a turn, a stop, etc.).

At block 504, the route displaying circuitry 208 updates the current position of the aircraft 100 in relation to the portion of the navigation instructions. In other words, the current position of the aircraft 100 is updated according to a completion percentage or status along the generated taxi route.

At block 506, the route displaying circuitry 208 displays an indicator corresponding to an anticipated action. In some examples, the anticipated action includes a turn, a hold-short/stop, a proceed, or any other suitable action. In some examples, the indicator includes a visual indicator on the display device 200 indicating the anticipated action to be taken. In some examples, an audible indicator may also be present in addition to or in lieu of the visual indicator. Once the action has been completed, the indicator corresponding to the anticipated action is removed from the display device 200 and/or the audible indicator is stopped.

In some examples, the pilot may want to be aware of a future position of the aircraft 100 along the generated taxi route, so as to prepare for any anticipated actions or view a portion of the generated taxi route not being displayed. In such an example, the route displaying circuitry 208 displays an anticipated position of the aircraft 100 corresponding to a future portion of the generated taxi route at block 508. Accordingly, the pilot selects a position along the generated taxi route for the route displaying circuitry 208 to display the anticipated position of the aircraft 100.

Further, in some examples, unexpected events may occur or additional instructions may be received by the communication circuitry 202 that may require a deviation from the generated taxi route during execution of the navigation instructions. Accordingly, at block 510, the route displaying circuitry 208 displays a route comparison between the generated taxi route and the alternative route generated by the route generation circuitry 206. In such an example, the pilot can choose which of the displayed routes to choose based on the comparison, and the route generation circuitry 206 and the route displaying circuitry 208 will update accordingly.

FIG. 6 is a block diagram of a computing device 600 configured to execute the processes of FIGS. 3-5. The computing device 600 includes a processing unit 602, at least one memory 604, computer-executable instructions 606, and an interface 608. The processing unit 602 (or processing circuitry) communicates with the memory 604 and the interface 608 via a bus 610 configured to handle communication of data between the aforementioned components. The interface 608 is in communication, either wired or wirelessly, with one or more external devices 612. Examples of the one or more external devices 612 include flight displays, flight controls, full-authority digital engine controller(s) (FADECs), and/or any other suitable device

The systems and devices described herein (e.g., communication circuitry 202, interactive circuitry 204, route generation circuitry 206, and the route displaying circuitry 208) may include a controller or the computing device 600 comprising the processing unit 602 and the memory 604 which has stored therein the computer-executable instructions 606 for implementing the processes described herein. The processing unit 602 may comprise any suitable devices configured to cause a series of steps to be performed so as to implement the method such that instructions, when executed by the computing device 600 or other programmable apparatus, may cause the functions/acts/steps specified in the methods described herein to be executed. The processing unit 602 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 604 may be any suitable known or other machine-readable storage medium. The memory 604 may comprise non-transitory computer readable storage medium such as, for example, but not limited to, an electronic, magnetic, optical, electromagnetic, infrared, or semiconductor system, apparatus, or device, or any suitable combination of the foregoing. The memory 604 may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory 604 may comprise any storage means (e.g., devices) suitable for retrievably storing the computer-executable instructions 606 executable by processing unit 602. It should be understood that more than one memory 604 can be present in the computing device 600.

The methods and systems described herein may be implemented in a high-level procedural or object-oriented programming or scripting language, or a combination thereof, to communicate with or assist in the operation of the controller or computing device 600. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. In some examples, the program code may be delivered via coded instructions 614, which can be in the form of any of the aforementioned storage media of device. The program code may be readable by a general or special-purpose programmable computer for configuring and operating the computer when the storage media or device is read by the computer to perform the procedures described herein.

The computer-executable instructions 606 may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A method for assisting a pilot navigate an airport while taxiing an aircraft, the method comprising:
receiving taxi instructions for the aircraft to reach a destination from an origin;
generating at least one taxi route for the aircraft to reach the destination from the origin;
displaying navigation instructions corresponding to one of the at least one generated taxi route via a display device of the aircraft; and
executing the navigation instructions according to the generated taxi route.

2. The method according to claim 1, further including inserting the received taxi instructions into the display device of the aircraft prior to generating the at least one taxi route.

3. The method according to claim 1, further including modifying the navigation instructions when a change to the at least one generated taxi route has been detected.

4. The method according to claim 1, wherein the at least one taxi route is generated based on one or more additional considerations comprising:
identifying predetermined or common taxi routes at the airport;
determining a desired fuel economy criteria; or
identifying anchor points inserted into taxi route.

5. The method according to claim 1, further including generating a taxi route preview corresponding to the at least one generated taxi routes.

6. The method according to claim 5, further including updating the route preview based on changes made to the at least one generated taxi route after generating the route preview.

7. The method according to claim 1, further including generating a prompt to confirm one of the at least one generated taxi route to generate the navigation instructions.

8. The method according to claim 7, further including displaying a portion of the navigation instructions and a current position of the aircraft on the display device.

9. The method according to claim 8, further including updating the portion of the navigation instructions based on the current position of the aircraft.

10. The method according to claim 1, further including generating at least one indicator corresponding to an anticipated action during execution of the navigation instructions.

11. The method according to claim 1, wherein the navigation instructions are displayed on a map corresponding to the airport.

12. The method according to claim 1, further including displaying an anticipated position of the aircraft corresponding to a future position of the navigation instructions.

13. The method according to claim 1, further including comparing the at least one generated taxi route with an alternative route.

14. The method according to claim 13, wherein the comparison is performed prior to or during execution of the navigation instructions.

15. An apparatus for assisting a pilot navigate an airport while taxiing an aircraft, said apparatus comprising processing circuitry configured to execute machine-readable instructions to perform the method according to claim 1.

16. An aircraft comprising:
a fuselage;
a pair of wings attached to the fuselage;
at least one engine configured to propel the aircraft; and
the apparatus according to claim 15.

17. A non-transitory computer readable medium comprising:
memory;
machine-readable instructions stored on the memory; and
a processing unit configured to execute the machine-readable instructions to perform the method according to claim 1.
